(19) United States
(12) Patent Application Publication
(10) Pub. No.: US 2008/0031180 A1
(43) Pub. Date: Feb. 7, 2008

(54) FRAME STRUCTURE, WIRELESS COMMUNICATION APPARATUS, AND METHOD FOR ASSIGNING THE SAME

(75) Inventors: Chih-Chiang Hsieh, Kaohsiung County (TW); Yi-Hsueh Tsai, Taipei County (TW); Heng-Iang Hsu, Taipei (TW); Yung-Ting Lee, Taipei (TW); Kan-Chei Loa, Taipei (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: INSTITUTE FOR INFORMATION INDUSTRY, Taipei (TW)

(21) Appl. No.: 11/748,710

(22) Filed: May 15, 2007

Related U.S. Application Data
(60) Provisional application No. 60/821,320, filed on Aug. 3, 2006.

(51) Int. Cl. H04B 7/14

(52) U.S. Cl. 370/315

(57) ABSTRACT

A frame structure for an IEEE 802.16j standard, a wireless communication apparatus and a method for assigning the same in a wireless communication system are provided. The wireless communication system comprises a base station (BS), a mobile station (MS), and a relay station (RS). The frame structure comprises an MS sub-frame and an RS sub-frame. The MS sub-frame is used for transmitting data between the RS and the MS. The RS sub-frame is used for transmitting data between the RS and the BS.

### CROSS-REFERENCES TO RELATED APPLICATIONS

This application claims the benefit of Provisional Application Ser. No. 60/821,320 filed on Aug. 3, 2006.

### BACKGROUND OF THE INVENTION

1. Field of the Invention

The present invention relates to a frame structure, a wireless communication apparatus, and a method for assigning the same; more specifically, it relates to a frame structure, a wireless communication apparatus, and a method for assigning the same in a IEEE 802.16j standard wireless communication system comprising multi-hop relay stations.

2. Descriptions of the Related Art

With the rapid development of computer networks, various broadband services are becoming more essential for the information industry. However, due to the costs, only a fraction of all computer users can afford high speed wired broadband services, such as digital subscribe line (DSL) and the cable broadband access. From the viewpoint of network telecommunication service providers, they desire to expand the coverage range of the wired broadband network. However, the related infrastructure costs for building the wired network prevents them from doing so. Broadband wireless techniques, hence, have become an important alternatives.solution. In terms of communication distance, the current techniques of the wireless network can be classified into the wide area network (WAN), the metropolitan area network (MAN), the local area network (LAN), and the personal area network (PAN).

IEEE 802.16, a worldwide interoperability for microwave access (WiMax), is a newly developing wireless transmission standard. The original establishing objective was to set up a radio standard for the metropolitan network to provide wireless broadband connection as “the last mile” for the telecommunication industry. After continuous improvement, the IEEE 802.16 has been able to address more market demands, such as various mobile and high speed broadband applications. Furthermore, in comparison to other communication techniques, such as Wi-Fi and the third generation mobile communication (3G) technique, the IEEE 802.16 has a larger network bandwidth, lower construction cost, better service quality, better expandability, and extended usage mode at a Wi-Fi hot spot.

Although the IEEE 802.16 standard already provides greater bandwidths, lower building cost, better service quality and expandability, there are still limits to the coverage and signal quality.

Therefore, the IEEE 802.16j standard Working Group has established a mobile multi-hop relay study group in July, 2005 for building a mobile multi-hop relay standard (MMR-RS). Accordingly, it is important to find a solution for expanding coverage and improving signal quality using the mobile multi-hop relay standard in the IEEE 802.16j standard.

### SUMMARY OF THE INVENTION

One objective of this invention is to provide a frame structure for the IEEE 802.16j standard for use in a wireless communication system comprising a base station (BS), a mobile station (MS), and a relay station (RS). The frame structure comprises an MS sub-frame and an RS sub-frame. The MS sub-frame transmits data between the RS and the MS. The RS sub-frame transmits data between the RS and the BS. The RS sub-frame occurs later than the MS sub-frame.

A further objective of this invention is to provide a method for assigning a frame structure for transmitting data in the IEEE 802.16j standard. The method comprises the following steps: assigning an MS sub-frame to the frame structure for transmitting data between the RS and MS; and assigning an RS sub-frame for transmitting data between the RS and BS. The RS sub-frame occurs later than the MS sub-frame.

Yet a further objective of this invention is to provide a wireless communication apparatus capable of assigning a frame structure to transmit data based on the IEEE 802.16j standard in a wireless communication system comprising a BS, a MS, and a RS. The frame structure has an MS sub-frame and an RS sub-frame. The MS sub-frame transmits data between the RS and MS. The RS sub-frame transmits data between the RS and BS. The RS sub-frame occurs later than the MS sub-frame.

Therefore, the frame structure of the present invention based on the IEEE 802.16j standard can be used in a mobile multi-hop relay standard based on the IEEE 802.16j standard. Accordingly, the coverage and signal quality of the EEE 802.16 standard can be improved using the above frame structure of the IEEE 802.16j standard.

The detailed technology and preferred embodiments implemented for the subject invention are described in the following paragraphs accompanying the appended drawings for people skilled in the art to well appreciate the features of the claimed invention.

### BRIEF DESCRIPTION OF THE DRAWINGS

FIG. 1 is a schematic diagram illustrating a two-hop relay station system based on the MMR-RS of the IEEE 802.16j standard of a first embodiment of the present invention;

FIG. 2 is a schematic diagram illustrating one type of frame structure for the two-hop relay station system;

FIG. 3 and FIG. 4 are schematic diagrams illustrating other types of frame structures for the two-hop relay station system;

FIG. 5 is a schematic diagram illustrating a multi-hop relay station system based on the MMR-RS of the IEEE 802.16j standard of a second embodiment of the present invention;

FIG. 6 is a schematic diagram illustrating one type of frame structure for the multi-hop relay station system;

FIG. 7 and FIG. 8 are schematic diagrams illustrating other types of frame structure for the multi-hop relay station system;

FIG. 9 is a flow chart of a third embodiment of the present invention; and

FIG. 10 is a flow chart of a fourth embodiment of the present invention.

### DESCRIPTION OF THE PREFERRED EMBODIMENT

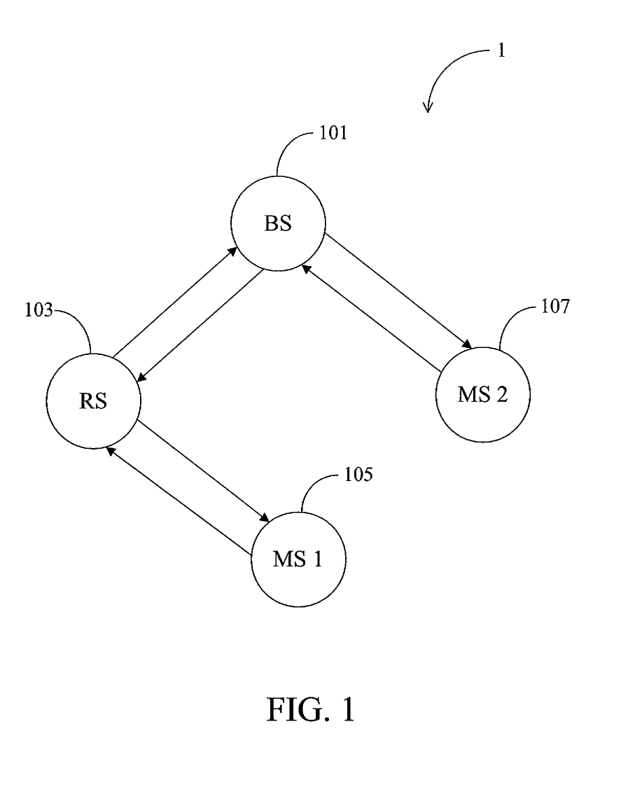

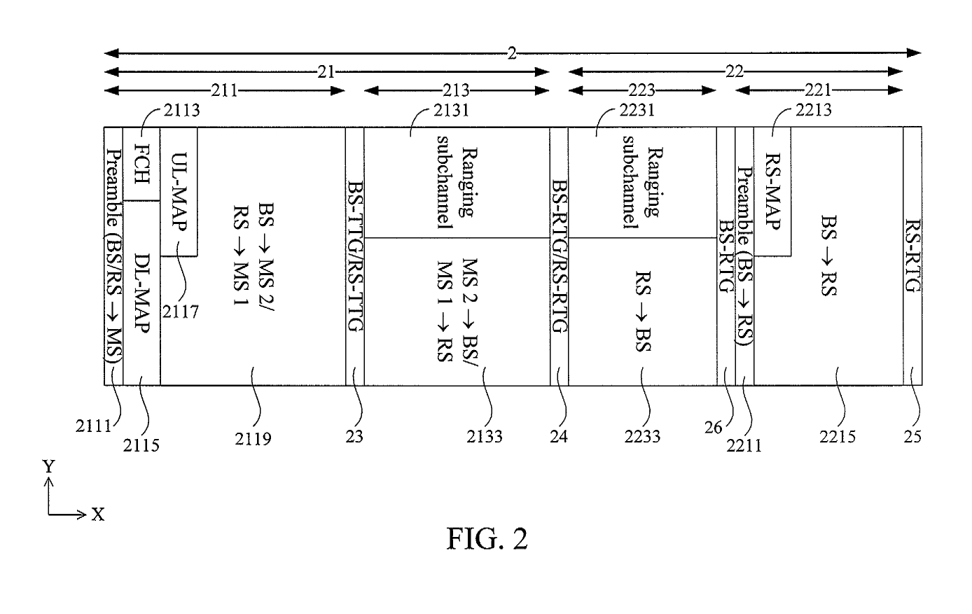

The first embodiment is a two-hop relay station system 1 based on the MMR-RS of the IEEE 802.16j standard as illustrated in FIG. 1. The two-hop relay station system 1 comprises a BS 101, an RS 103, and a plurality of MSs 105, 107. For simplification, two MSs, referred to t as the first MS 105 and the second MS 107, are illustrated here. One type of frame structure 2 for the two-hop relay station system 1 is illustrated in FIG. 2. The frame structure 2 is assigned by a wireless communication apparatus, such as the BS 101, the RS 103, the first MS 105, or the second MS 107.

The frame structure 2 of the two-hop relay station system 1 comprises an MS sub-frame 21 and an RS sub-frame 22, which may operate downlink and uplink accesses to the two-hop relay station system 1 independently. The MS sub-frame 21 comprises an MS downlink sub-frame 211 and an MS uplink sub-frame 213. The RS sub-frame 22 comprises an RS downlink sub-frame 221 and an RS uplink sub-frame 223. The X axis presents time division of the frame structure 2, while the Y axis presents frequency division of the frame structure 2.

The MS downlink sub-frame 211 of the MS sub-frame 21 further comprises a preamble 2111, a frame control head (FCH) 2113, a downlink-MAP 2115, an uplink-MAP 2117, and a data allocation 2119. The preamble 2111 is used for synchronization between the BS 101 and the second MS 107 or between the RS 103 and the first MS 105. The frame control head 2113 is used for describing each parameter of the frame structure 2. The downlink-MAP 2115 is used for broadcasting some transmitting parameters of the downlink accesses of the two-hop relay station system 1, such as connection identification, sub-channel offset, time offset, etc. The uplink-MAP 2117 is used for broadcasting some transmitting parameters of the uplink accesses of the two-hop relay station system 1. The data allocation 2119 is used for transmitting data from the BS 101 to the second MS 107 or from the RS 103 to the first MS 105. After the data allocation 2119 is transmitted, there is a BS-transmission transition gap (BS-TTG) 23 or a RS-transmission transition gap (RS-TTG) 23, which occurs later than the MS downlink sub-frame 211.

The MS uplink sub-frame 213 of the MS sub-frame 21 further comprises a ranging sub-channel 2131 and a data allocation 2133. The ranging sub-channel 2131 is used for ranging between the second MS 107 and the BS 101 or between the first MS 105 and the RS 103. The data allocation 2133 is used for transmitting data from the second MS 107 to the BS 101 or from the first MS 105 to the RS 103. After the data allocation 2133 is transmitted, there is a BS-receive transition gap (BS-RTG) 24 or a RS-receive transition gap (RS-RTG) 24 that occurs later than the MS uplink sub-frame 213.

The RS downlink sub-frame 221 of the RS sub-frame 22 further comprises a preamble 2211, an RS-MAP 2213, and data allocation 2215. The preamble 2211 is used for synchronization between the BS 101 and the RS 103. The RS-MAP 2213 is used for broadcasting some transmitting parameters of the RS 103. The data allocation 2215 is used for transmitting data from the BS 101 to the RS 103. After the data allocation 2215 is transmitted, the RS-RTG 25 occurs later than the RS downlink sub-frame 221.

The RS uplink sub-frame 223 of the RS sub-frame 22 further comprises a ranging sub-channel 2231 and data allocation 2233. The ranging sub-channel 2231 is used for ranging between the RS 103 and the BS 101. The data allocation 2233 is used for transmitting data from the RS 103 to the BS 101. After the data allocation 2233 is transmitted, the BS-RTG 26 occurs later than the RS uplink sub-frame 223.

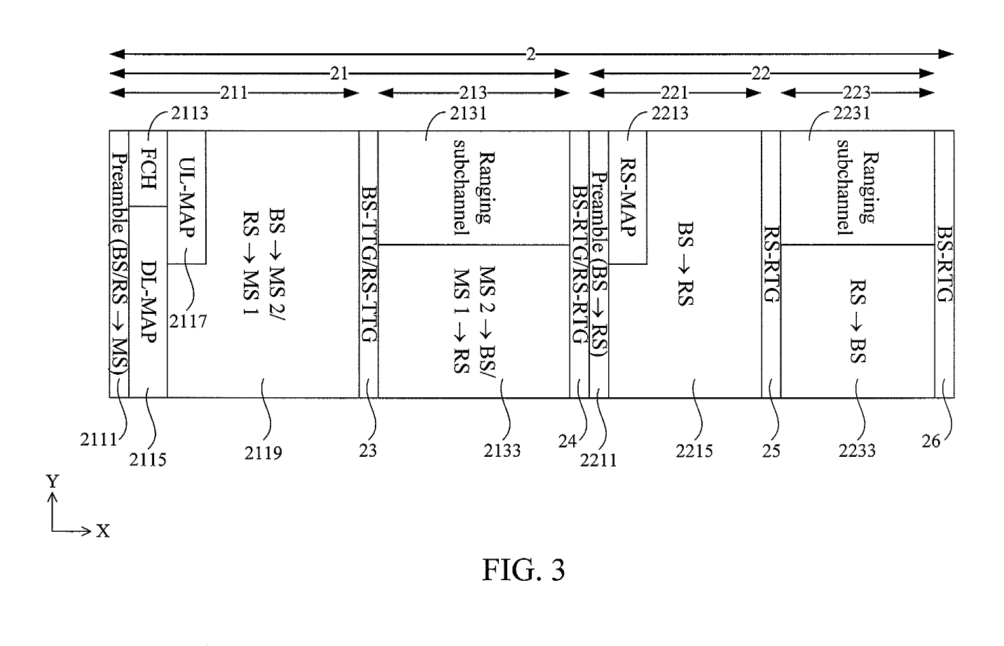

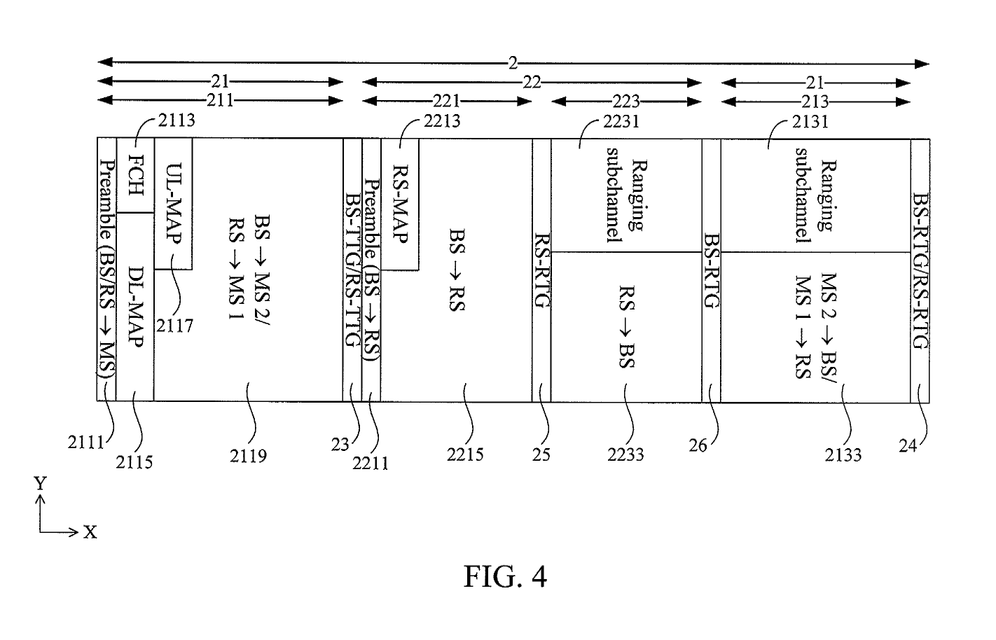

According to the aforementioned descriptions, the MS downlink sub-frame 211 of the MS sub-frame 21 comprises the downlink-MAP 2115 and the uplink-MAP 2117 so that the MS downlink sub-frame 211 can occur earlier than the MS uplink sub-frame 213, the RS downlink sub-frame 221, or the RS uplink sub-frame 223. This way, the frame structure 2 can be transmitted normally. The present invention does not limit the positions of the MS uplink sub-frame 213, the RS downlink sub-frame 221, and the RS uplink sub-frame 223. The MS uplink sub-frame 213, the RS downlink sub-frame 221, and the RS uplink sub-frame 223 can be positioned in any sequence behind the MS downlink sub-frame 211. There are other types of frame structures 2 for the two-hop relay station system 1 as illustrated in FIG. 3 and FIG. 4. Those skilled in the art can easily realize other types of frame structures 2 for the two-hop relay station system 1.

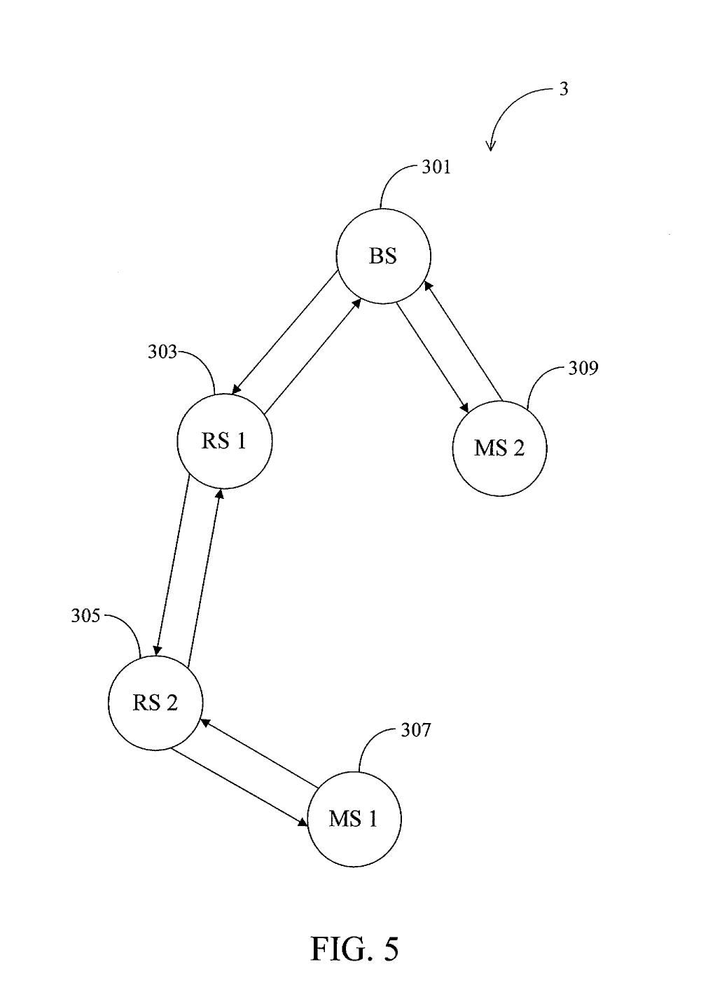

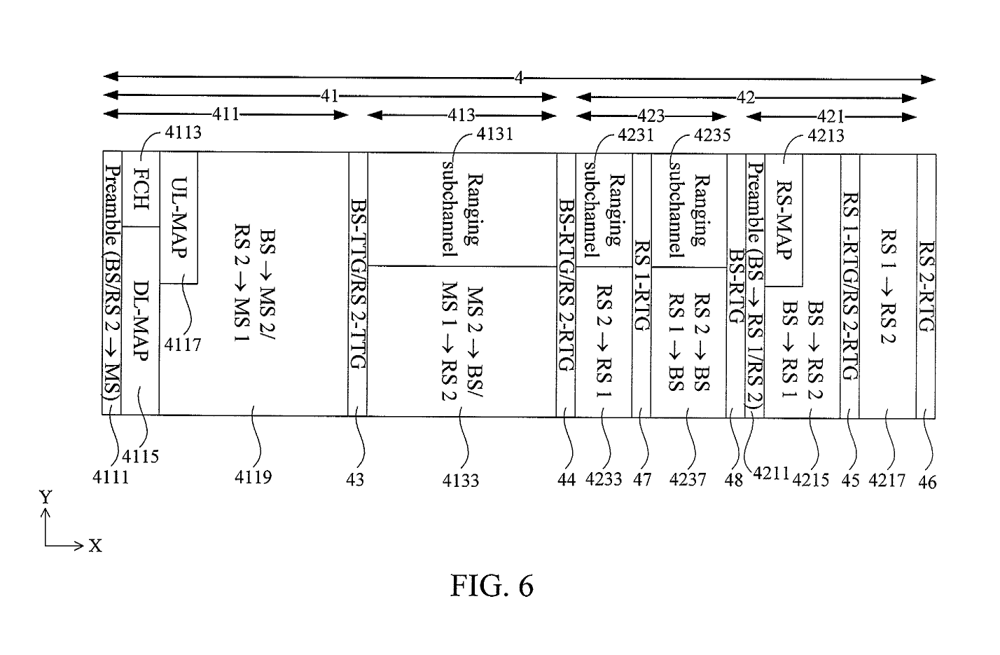

A second embodiment is a multi-hop relay station system 3 based on the MMR-RS of the IEEE 802.16j standard as illustrated in FIG. 5. The multi-hop relay station system 3 comprises a BS 301, a plurality of RSs 303, 305, and a plurality of MSs 307, 309. For simplification, the two RSs are referred to as the first RS 303 and the second RS 305, while the two MSs are referred to as the first MS 307 and the second MS 309. One type of frame structure 4 for the multi-hop relay station system 3 is illustrated in FIG. 6, and the frame structure 4 is assigned by a wireless communication apparatus, such as the BS 301, the first RS 303, the second RS 305, the first MS 307, and the second MS 309.

The frame structure 4 for the multi-hop relay station system 3 comprises an MS sub-frame 41 and an RS sub-frame 42, which may operate downlink and uplink accesses of the two-hop relay station system 3 independently. The MS sub-frame 41 comprises an MS downlink sub-frame 411 and an MS uplink sub-frame 413. The RS sub-frame 42 comprises an RS downlink sub-frame 421 and an RS uplink sub-frame 423. The X axis presents the time division of the frame structure 4, while the Y axis presents the frequency division of the frame structure 4.

The MS downlink sub-frame 411 of the MS sub-frame 41 further comprises a preamble 4111, an FCH 4113, a downlink-MAP 4115, an uplink-MAP 4117, and a data allocation 4119. The preamble 4111 is used for synchronization between the BS 301 and the second MS 309 or between the second RS 305 and the first MS 307. The frame control head 4113 is used for describing each parameter of the frame structure 4. The downlink-MAP 4115 is used for broadcasting some transmitting parameters of the downlink accesses of the multi-hop relay station system 3, such as the connection identification, sub-channel oddest, time offset, etc. The uplink-MAP 4117 is used for broadcasting some transmitting parameters of the uplink accesses of the multi-hop relay station system 3. The data allocation 4119 is used for transmitting data from the BS 301 to the second MS 309 or from the second RS 305 to the first MS 307. After the data allocation 4119 is transmitted, there is a BS-transmission transition gap (BS-TTG) 43 or a second RS-transmission transition gap (RS 2-TTG) 43, which occurs later than the MS downlink sub-frame 411.

The MS uplink sub-frame 413 of the MS sub-frame 41 further comprises a ranging sub-channel 4131 and data allocation 4133. The ranging sub-channel 4131 is used for ranging between the second MS 309 and BS 301 or between the first MS 307 and the second RS 305. The data allocation 4133 is used for transmitting data from the second MS 309 to the BS 301 or from the first MS 307 to the second RS 305. After the data allocation 4133 is transmitted, there is a BS-receive transition gap (BS-RTG) 44 or a second RS-receive transition gap (RS 2-RTG) 44, which occurs later than the MS uplink sub-frame 413. The RS downlink sub-frame 421 of the RS sub-frame 42 further comprises a preamble 4211, a RS-MAP 4213, and a plurality of data allocations 4215, 4217. The preamble 4211 is used for synchronization between the BS 301 and the first RS 303 or between the BS 301 and the second RS 305. The RS-MAP 4213 is used for broadcasting some transmitting parameters of the first RS 303 and the second RS 305. The data allocation 4215 is used for transmitting data from the BS 301 to the first RS 303 or from the BS 301 to the second RS 305. After the data allocation 4215 is transmitted, there is a first RS-receive transition gap (RS 1-RTG) 45 or a RS 2-RTG 45, which occurs later than the data allocation 4215. The data allocation 4217 is used for transmitting data from the first RS 303 to the second RS 305. After the data allocation 4217 is transmitted, there is a RS 2-RTG 46, which occurs later than the data allocation 4217.

The RS uplink sub-frame 423 of the RS sub-frame 42 further comprises ranging sub-channels 4231, 4235 and data allocations 4233, 4237. The ranging sub-channel 4231 is used for ranging between the second RS 305 and the first RS 303, while the ranging sub-channel 4235 is used for ranging between the second RS 305 and the BS 301 or between the first RS 303 and the BS 301. The data allocation 4233 is used for transmitting data from the second RS 305 to the first RS 303, while the data allocation 4237 is used for transmitting data from the second RS 305 to the BS 301 or from the first RS 303 to the BS 301. After the data allocation 4233 is transmitted, there is a RS 1-RTG 47 occurring later than the ranging sub-channel 4231 and the data allocations 4233. After the data allocation 4237 is transmitted, there is a BS-RTG 48, which occurs later than the ranging sub-channel 4235 and data allocations 4237.

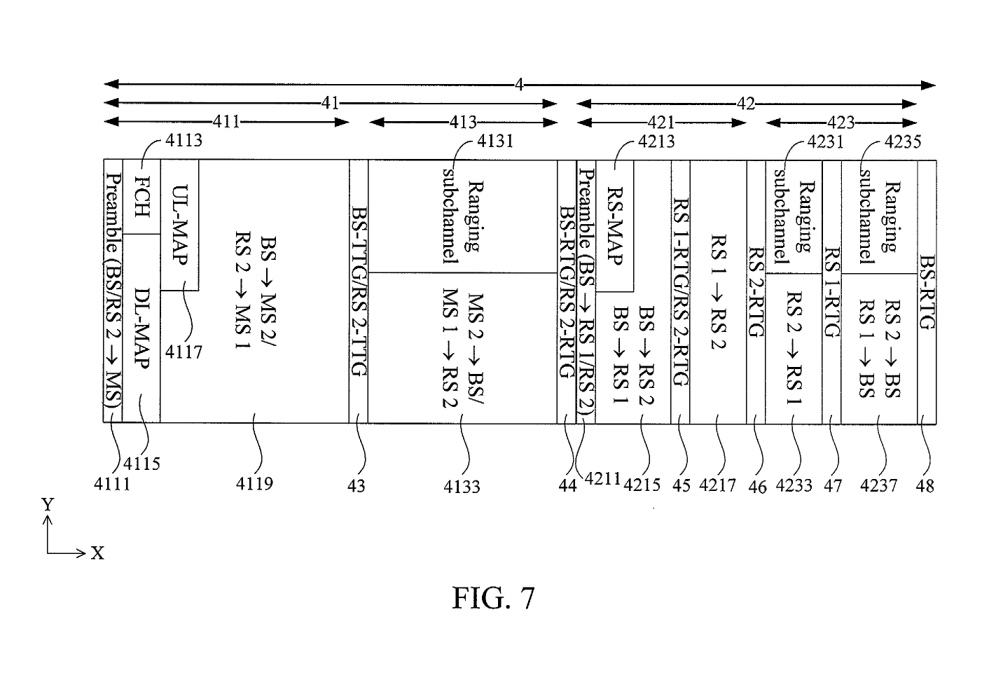

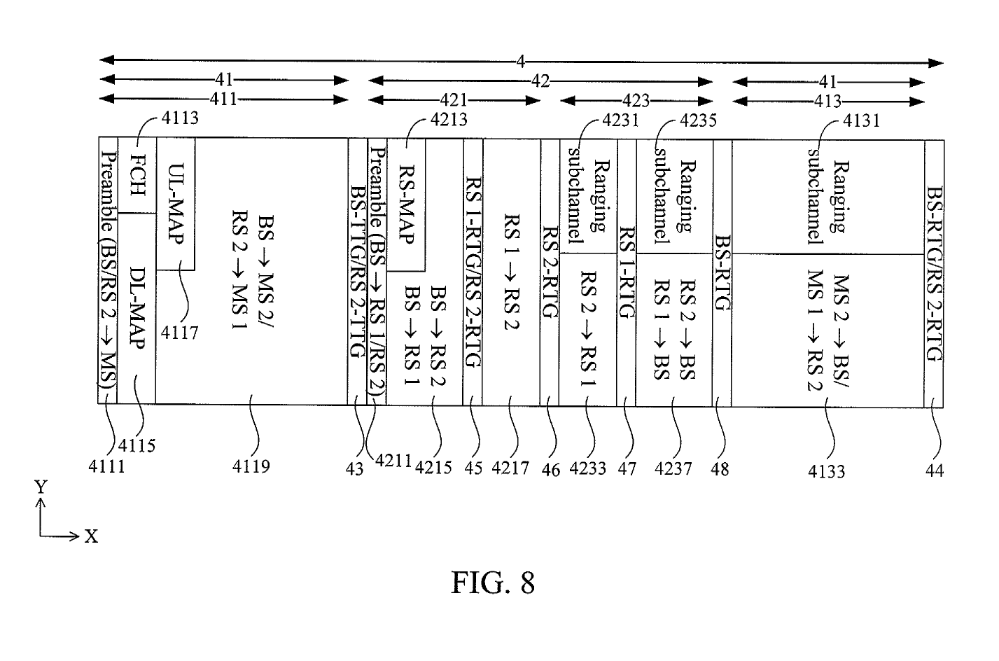

According to the aforementioned descriptions, the MS downlink sub-frame 411 of the MS sub-frame 41 comprises the downlink-MAP 4115 and the uplink-MAP 4117 so that the MS downlink sub-frame 411 can occur earlier than the MS uplink sub-frame 413, the RS downlink sub-frame 421, or the RS uplink sub-frame 423. This way, the frame structure 4 can be transmitted normally. The present invention does not limit the positions of the MS uplink sub-frame 413, the RS downlink sub-frame 421, and the RS uplink sub-frame 423. The MS uplink sub-frame 413, the RS downlink sub-frame 421, and the RS uplink sub-frame 423 can be positioned in any sequence behind the MS downlink sub-frame 411. There are other types of frame structures 4 for the multi-hop relay station system 3 as illustrated in FIG. 7 and FIG. 8. Those skilled in the art can easily realize other types of frame structures 4 for the multi-hop relay station system 3.

The present invention also does not limit the number of RSs. The second embodiment of this invention adopts two RSs for the multi-hop relay station system 3. However, this is only one example. The RS downlink sub-frame 421 and the RS uplink sub-frame 423 of the RS sub-frame 42 can be divided into more than two parts for data transmission. Those skilled in the art can easily understand the second embodiment by the explanation of the aforementioned descriptions, and thus no unnecessary detail is given.

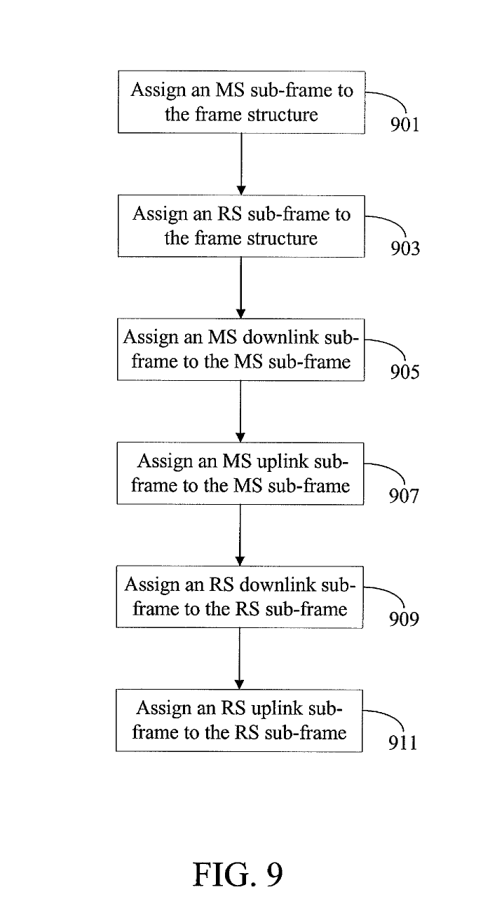

A third embodiment of this invention is to provide a method for assigning a frame structure for transmitting data based on the IEEE 802.16j standard. The method is applied to the two-hop relay station system 1 based on the MMR-RS of the IEEE 802.16j standard as described in the first embodiment. In particular, the method of the third embodiment is applied using a computer program to control the wireless communication apparatus, such as the BS 101, the RS 103, the first MS 105, and the second MS 107. The corresponding flow chart is shown in FIG. 9.

In the following steps, the steps are executed to allow the wireless communication apparatus to assign various sub-frames to the frame structure. First, in step 901, an MS sub-frame is assigned to the frame structure for transmitting data between the RS 103 and the first MS 105 or between the BS 101 and the second MS 107. Next, in step 903, an RS sub-frame is assigned to the frame structure for transmitting data between the RS 103 and the BS 101. Then, in step 905, an MS downlink sub-frame is assigned to the MS sub-frame for transmitting data from the RS 103 to the first MS 105 or from the BS 101 to the second MS 107. In step 907, an MS uplink sub-frame is assigned to the MS sub-frame for transmitting data from the first MS 105 to the RS 103 or from the second MS 107 to the BS 101. Then, in step 909, an RS downlink sub-frame is assigned to the RS sub-frame for transmitting data from the BS 101 to the RS 103. Finally, in step 911, an RS uplink sub-frame is assigned to the RS sub-frame for transmitting data from the RS 103 to the BS 101.

In addition to the steps revealed in FIG. 9, the third embodiment can also execute all the operations of the first embodiment, in which those skilled in the art can understand the corresponding steps and operations of the third embodiment by the explanation of the first embodiment, and thus no unnecessary detail is given.

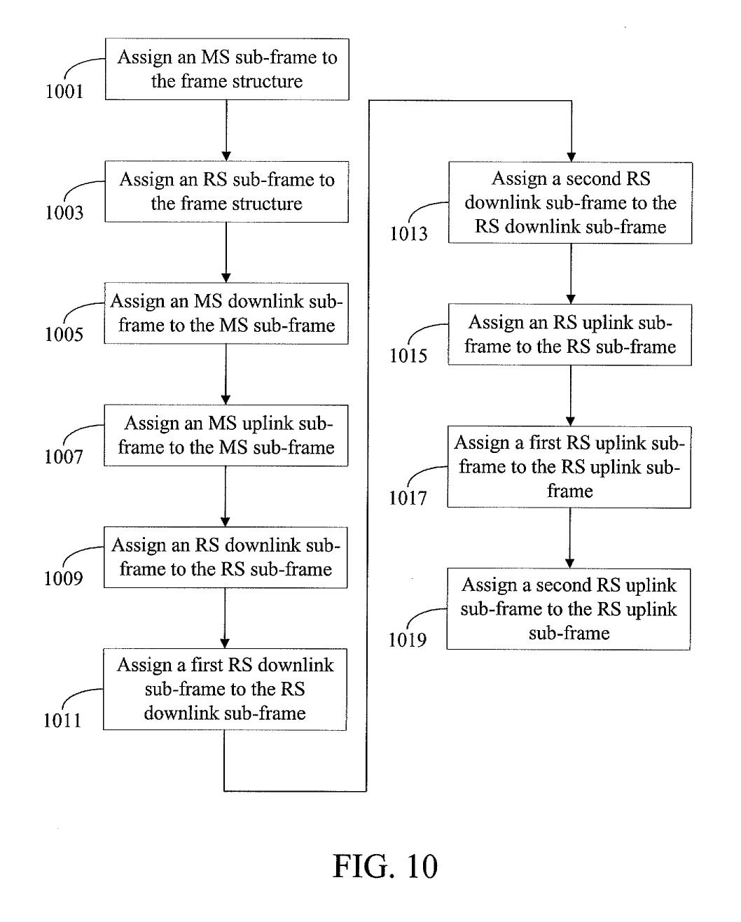

A fourth embodiment of this invention is to provide a method for assigning another frame structure of an IEEE 802.16j standard for transmitting data. This method is applied to the multi-hop relay station system 3 based on the MMR-RS of the IEEE 802.16j standard as described in the second embodiment. In particular, the method of the fourth embodiment is applied using a computer program which controls a wireless communication apparatus, such as the BS 301, the first RS 303, the second RS 305, the first MS 307, and the second MS 309. The corresponding flow chart is shown in FIG. 10.

In the following steps, the steps are executed to allow the wireless communication apparatus to assign various sub-frames to the frame structure. First, in step 1001, an MS sub-frame is assigned to the frame structure for transmitting data between the second RS 305 and the first MS 307 or between the BS 301 and the second MS 309. Next, in step 1003, an RS sub-frame is assigned to the frame structure for transmitting data between the first RS 303 and the BS 301 or between the second RS 305 and the BS 301, and between the first RS 303 and the second RS 305. Then, in step 1005, an MS downlink sub-frame is assigned to the MS sub-frame for transmitting data from the second RS 305 to the first MS 307 or from the BS 301 to the second MS 309. In step 1007, an MS uplink sub-frame is assigned to the MS sub-frame for transmitting data from the first MS 307 to the second RS 305 or from the second MS 309 to the BS 301.

Thereafter, in step 1009, an RS downlink sub-frame is assigned to the RS sub-frame for transmitting data. Next, in step 1011, a first RS downlink sub-frame is assigned to the RS downlink sub-frame for transmitting data from the BS 301 to the first RS 303 or from the BS 301 to the second RS 305. In step 1013, a second RS downlink sub-frame is assigned to the RS downlink sub-frame for transmitting data from the first RS 303 to the second RS 305.

Then, in step 1015, an RS uplink sub-frame is assigned to the RS sub-frame for transmitting data. Next, in step 1017, a first RS uplink sub-frame is assigned to the RS uplink sub-frame for transmitting data from the first RS 303 to the BS 301 or from the second RS 305 to the BS 301. In step 1019, a second RS uplink sub-frame is assigned to the RS uplink sub-frame for transmitting data from the second RS 305 to the first RS 303.

In addition to the steps revealed in FIG. 10, the fourth embodiment can also execute all the operations of the second embodiment, in which those skilled in the art can understand the corresponding steps and operations of the fourth embodiment by the explanation of the second embodiment, and thus no unnecessary detail is given.

According to the aforementioned descriptions, this invention provides a new frame structure for the IEEE 802.16j standard. As a result, the coverage and signal quality of the IEEE 802.16 standard can be expanded and improved using this new frame structure for the IEEE 802.16j standard.

The above disclosure is related to the detailed technical contents and inventive features thereof. People skilled in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A frame structure of the IEEE 802.16j standard for use in a wireless communication system comprising a base station (BS), a first mobile station (MS), and a first relay station (RS), the frame structure comprising:
an MS sub-frame for transmitting data between the first RS and the first MS; and
an RS sub-frame for transmitting data between the first RS and the BS;

2. The frame structure of claim 1, wherein the MS sub-frame comprises:
an MS downlink sub-frame for transmitting data from the first RS to the first MS; and
an MS uplink sub-frame for transmitting data from the first MS to the first RS.

3. The frame structure of claim 2, wherein the MS uplink sub-frame occurs later than the MS downlink sub-frame.

4. The frame structure of claim 1, wherein the RS sub-frame comprises:
an RS downlink sub-frame for transmitting data from the BS to the first RS; and
an RS uplink sub-frame for transmitting data from the first RS to the BS.

5. The frame structure of claim 4, the wireless communication system further comprising a second RS, wherein the first RS transmits data to the second RS in the RS downlink sub-frame and the second RS transmits data to the first RS in the RS uplink sub-frame.

6. The frame structure of claim 4, the wireless communication system further comprising a second RS, wherein the RS downlink sub-frame comprises:
a first RS downlink sub-frame for transmitting data from the BS to the first RS; and
a second RS downlink sub-frame for transmitting data from the first RS to the second RS.

7. The frame structure of claim 4, the wireless communication system further comprising a second RS, wherein the RS uplink sub-frame comprises:
a first RS uplink sub-frame for transmitting data from the first RS to the BS; and
a second RS uplink sub-frame for transmitting data from the second RS to the first RS.

8. The frame structure of claim 1, the wireless communication system further comprising a second RS and a second MS, wherein the second RS and the second MS transmit data to each other in the MS sub-frame.

9. The frame structure of claim 8, wherein the MS sub-frame comprises:
an MS downlink sub-frame for transmitting data from the second RS to the second MS; and
an MS uplink sub-frame for transmitting data from the second MS to the second RS.

10. The frame structure of claim 1, the wireless communication system further comprising a third MS, and the BS and the third MS transmit data to each other in the MS sub-frame.

11. The frame structure of claim 10, wherein the MS sub-frame comprises:
an MS downlink sub-frame for transmitting data from the BS to the third MS; and
an MS uplink sub-frame for transmitting data from the third MS to the BS.

12. The frame structure of claim 11, wherein the MS uplink sub-frame occurs later than the MS downlink sub-frame.

13. A method for assigning a frame structure for transmitting data based on the IEEE 802.16j standard, comprising steps of:
assigning an MS sub-frame to the frame structure for transmitting data between a first RS and a first MS; and
assigning an RS sub-frame to the frame structure for transmitting data between the first RS and a BS;

14. The method of claim 13, further comprising the steps of:
assigning an MS downlink sub-frame to the MS sub-frame for transmitting data from the first RS to the first MS; and
assigning an MS uplink sub-frame to the MS sub-frame for transmitting data from the first MS to the first RS.

15. The method of claim 14, wherein the MS uplink sub-frame occurs later than the MS downlink sub-frame.

16. The method of claim 14, wherein the second RS transmits data to a second MS in the MS downlink sub-frame, and the second MS transmits data to the second RS in the MS uplink sub-frame.

17. The method of claim 14, wherein the BS transmits data to a third MS in the MS downlink sub-frame, and the third MS transmits data to the BS in the MS uplink sub-frame.

18. The method of claim 13, further comprising the steps of:
assigning an RS downlink sub-frame to the RS sub-frame for transmitting data from the BS to the first RS; and
assigning an RS uplink sub-frame to the RS sub-frame for transmitting data from the first RS to the BS.

19. The method of claim 18, further comprising the steps of:
assigning a first RS downlink sub-frame to the RS downlink sub-frame for transmitting data from the BS to the first RS; and
assigning a second RS downlink sub-frame to the RS downlink sub-frame for transmitting data from the first RS to a second RS.

20. The method of claim 18, further comprising the steps of:
assigning a first RS uplink sub-frame to the RS uplink sub-frame for transmitting data from the first RS to the BS; and
assigning a second RS uplink sub-frame to the RS uplink for transmitting data from the second RS to the first RS.

21. A wireless communication apparatus capable of assigning a frame structure to transmit data based on the IEEE 802.16j standard in a wireless communication system comprising a BS, a first MS, and a first RS, the frame structure having:
an MS sub-frame for transmitting data between the first RS and the first MS; and
an RS sub-frame for transmitting data between the first RS and the BS;

22. The wireless communication apparatus of claim 21, wherein the MS sub-frame has:
an MS downlink sub-frame for transmitting data from the first RS to the first MS; and
an MS uplink sub-frame for transmitting data from the first MS to the first RS.

23. The wireless communication apparatus of claim 22, wherein the MS uplink sub-frame occurs later than the MS downlink sub-frame.

24. The wireless communication apparatus of claim 21, wherein the RS sub-frame has:
an RS downlink sub-frame for transmitting data from the BS to the first RS; and
an RS uplink sub-frame for transmitting data from the first RS to the BS.

25. The wireless communication apparatus of claim 24, the wireless communication system further comprising a second RS, wherein the first RS transmits data to the second RS in the RS downlink sub-frame, and the second RS transmits data to the first RS in the RS uplink sub-frame.

26. The wireless communication apparatus of claim 24, the wireless communication system further comprising a second RS, wherein the RS downlink sub-frame has:
a first RS downlink sub-frame for transmitting data from the BS to the first RS; and
a second RS downlink sub-frame for transmitting data from the first RS to the second RS.

27. The wireless communication apparatus of claim 24, the wireless communication system further comprising a second RS, wherein the RS uplink sub-frame has:
a first RS uplink sub-frame for transmitting data from the first RS to the BS; and
a second RS uplink sub-frame for transmitting data from the second RS to the first RS.

28. The wireless communication apparatus of claim 21, the wireless communication system further comprising a second RS and a second MS, wherein the second RS and the second MS transmit data to each other in the MS sub-frame.

29. The wireless communication apparatus of claim 28, wherein the MS sub-frame has:
an MS downlink sub-frame for transmitting data from the second RS to the second MS; and
an MS uplink sub-frame for transmitting data from the second MS to the second RS.

30. The wireless communication apparatus of claim 21, the wireless communication system further comprising a third MS, and the BS and the third MS transmit data to each other in the MS sub-frame.

31. The wireless communication apparatus of claim 30, wherein the MS sub-frame has:
an MS downlink sub-frame for transmitting data from the BS to the third MS; and
an MS uplink sub-frame for transmitting data from the third MS to the BS.

32. The wireless communication apparatus of claim 31, wherein the MS uplink sub-frame occurs later than the MS downlink sub-frame.
